(19) United States
(12) Patent Application Publication
(10) Pub. No.: US 2007/0065326 A1
(43) Pub. Date: Mar. 22, 2007

(54) ROTARY PISTON AND METHODS FOR OPERATING A ROTARY PISTON AS A PUMP, COMPRESSOR AND TURBINE

(76) Inventor: Robert J. Orsello, Scottsdale, AZ (US)

Correspondence Address: ARTZ & ARTZ, P.C., 28333 TELEGRAPH RD., SUITE 250, SOUTHFIELD, MI, 48034, US

(21) Appl. No.: 11/162,665

(22) Filed: Sep. 19, 2005

(51) Int. Cl. F01C 1/02; F16N 13/20; F01C 19/02; F03C 4/00; F04C 27/00

(52) U.S. Cl. 418/61.2; 418/113; 418/116

(57) ABSTRACT

A rotary piston (10) that is scalable from nano-scopic to giga-scopic domains and is capable of operating efficiently as a pump, compressor or turbine over a broad range of pressure and volume combinations for a variety of working substances is presented having a stator housing (12) having fixed internal dimensions (14) and being divided into at least one chamber (16) having seal boundaries in communication with a rotor body (26) and a vane body (38) where the vane body (38) is compressible and has a maximum length dimension (50) to create a low friction seal with the fixed internal dimension (14) of the stator housing (12) for the at least one chamber (16).

### TECHNICAL FIELD

The present invention is a rotary piston and more particularly a rotary piston that is scalable, operates over a broad range of pressure and volume combinations for a working substance and can be used as a turbine, pump or compressor.

### BACKGROUND ART

A rotary piston operates essentially like an infinitely long piston. In a piston, the work is done by a force exerted on a boundary face which separates an enclosed high-pressure chamber from a low pressure potential. As the high pressure drives the boundary face toward the low pressure, work is done. During this movement, the volume of the enclosed chamber containing the high pressure increases and the pressure decreases. Working force and motion continues until the enclosed chamber volume has expanded sufficiently to create equalized pressure on both sides of the boundary face.

Typically, a conventional piston is very difficult to scale and therefore it has not been practical to design pistons that are very large or very small. Making a conventional piston very large is not practical because as the piston chamber increases in size, so does the size of the piston, and its relative mass. Reciprocation of such a large mass is inefficient and becomes impractical. Making a conventional piston very small is also not practical because the seal rings around the circumference of the piston become a dominant component with respect to the area of the piston face. Further, a crankshaft can only reduce to a point before the piston's travel is impaired.

A conventional bladed turbine design only operates efficiently for a large flow volume and a high-pressure differential. Conventional turbines are not adaptable to a dynamic pressure and flow situation.

### SUMMARY OF INVENTION

A rotary piston that is scalable from nano-scopic to giga-scopic domains and is capable of operating efficiently over a broad range of pressure and volume combinations for a variety of working substances is presented. A stator housing having fixed internal dimensions is divided into at least one chamber having seal boundaries in communication with a rotor body and a vane body. The vane body is compressible and has a maximum length dimension to create a low friction seal with the fixed internal dimension of the stator housing for the at least one chamber.

The rotor body located in the stator housing has a slot therethrough in which the vane body is located. The vane body will slide within the vane slot during rotation and can have a small clearance to the stator housing, no clearance with the stator housing, or it can slightly compress against the stator housing.

In one embodiment, a feed control system delivers a working substance to the at least one chamber and the working substance is expanded from a high pressure and low volume to a low pressure and large volume in the at least one chamber. The feed control system is capable of controlling the feed rate and volume of working substance delivered to the chamber.

### BRIEF DESCRIPTION OF DRAWINGS

FIG. 1 is a cross section of the rotary piston of the present invention.

FIG. 2 is a cross section of the stator housing of the present invention.

FIG. 3 is a cross section of the rotor body of the present invention.

FIG. 4 is a cross section of the vane body of the present invention.

FIG. 5 is a diagram of the feed control system of the present invention.

FIG. 6 is a flow chart of the method for operating the rotary piston of the present invention as a pump and a compressor.

FIG. 7 is a flow chart of the method for operating the rotary piston of the present invention as a turbine.

### DETAILED DESCRIPTION

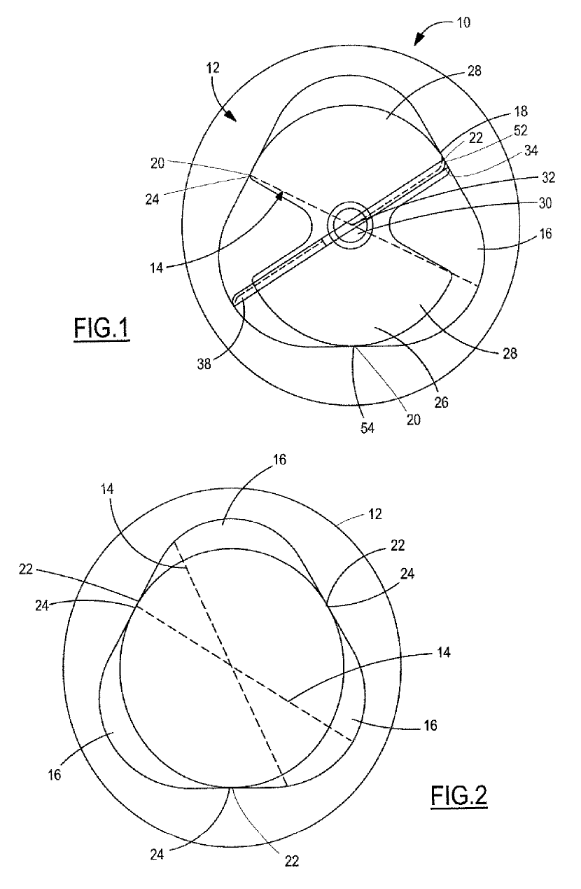

A cross section of a rotary piston 10 that is scalable in dimension from nano-scopic to giga-scopic domains is shown in FIG. 1. A stator housing 12 has a fixed internal dimension 14 that remains constant throughout the piston's 10 revolution. The stator housing 12 is divided into at least one chamber 16 and three chambers 16 are shown in FIG. 1 for example purposes only. It should be noted that one skilled in the art is capable of incorporating more, or fewer, chambers without departing from the scope of the present invention.

The stator housing 12 is shown in greater detail in FIG. 2. Each chamber 16 is bounded at a first end 18 and a second end 20 by a leading seal boundary 22 and a following seal boundary 24 respectively. The seal boundaries 22 and 24 are manufactured in the stator housing 12 so that minimal operational clearance exists with a rotor body (not shown in FIG. 2). Typically this is accomplished by machining the stator housing 12, but one skilled in the art is capable of substituting another method without departing from the scope of this invention. The labels of leading and following seal boundaries 22, 24 are determined by the direction of rotation of the rotary piston 10, which will be discussed in detail hereinafter.

The internal dimensions and characteristics, such as the number of chambers, the volume of the chambers, the profile of the chambers, etc., in the stator housing are a function of the application for the rotary piston 10 and are not limited to the embodiment shown in the Figures. However, the fixed internal dimension 14 of the stator housing requires that the dimension of any line, L1 and L2 in FIG. 2, that passes through a center point of the stator housing 12 is a fixed length and remains constant throughout 360 degrees of rotation of the internal dimension 14.

Referring again to FIG. 1, the rotor body 26 is shown in relation to the stator housing 12 and the chambers 16. The rotor body 26 is located inside the stator housing 12 and has a plurality of arms 28 (two arms are shown in FIG. 1). A center channel 30 is found at the center of the rotor body 26 and defines a shaft axis, as well as an axis of rotation 32 for the rotary piston 10. According to the present invention, it does not make a difference whether the rotary piston 10 is configured so that the stator housing 12 remains fixed and the rotor body 26 rotates or the rotor body 26 remains fixed and the stator housing rotates 12 about the axis of rotation 32. The operation of the rotary piston 10 and the relationship of the components is the same for each configuration.

The rotor body 26 has at least one vane slot 34 intersecting the center channel 30 and axis of rotation 32. Two rotor arms and one vane slot are shown in FIG. 1, but it should be noted that any number of arms and vane slots is possible according to the present invention, and the number shown is for the purposes of the detailed description only and in no way limits the present invention to the embodiment shown.

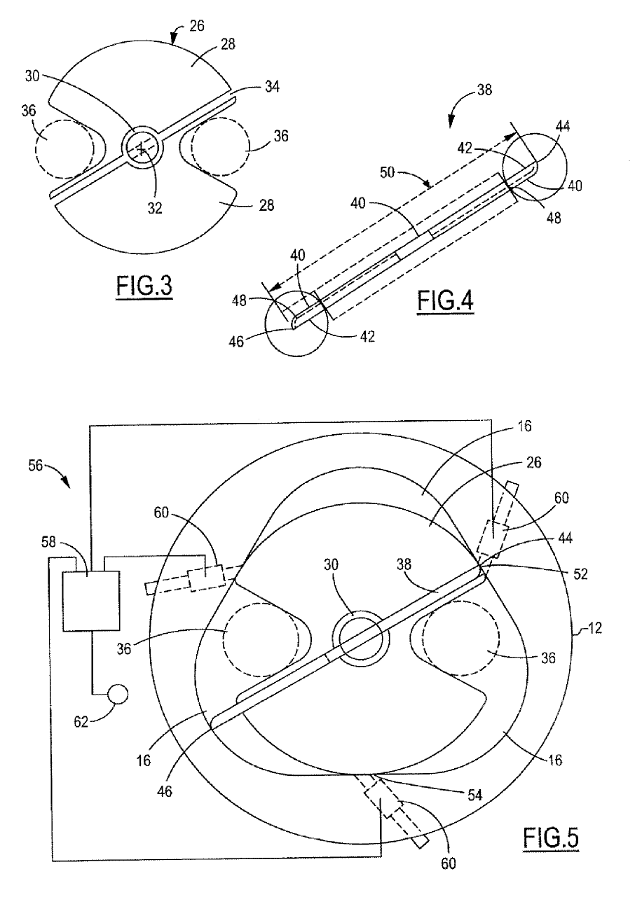

Referring to FIG. 3, the rotor body is shown in detail. In FIGS. 1 and 3, the rotor body 26 has two arms 28 and a single vane slot 34 passing through the center channel 30 at the axis of rotation 32. Channels 36 are provided for intake and exhaust of a working substance. Two channels 36 are shown as intake and exhaust channels in between the rotor arms 28. When the rotary piston 10 is operated as a pump or compressor, the channels 36 are used for intake of a working substance from an outside, or ambient, source. When the rotary piston 10 is operated as a turbine, the channels 36 are exhaust channels. It should be noted that while the channels 36 used for intake and exhaust are shown on the rotor body in the present embodiment, they may also be configured as a part of the stator housing. It should also be noted that while two channels 36 are shown, one skilled in the art is capable of incorporating more, or fewer, channels without departing from the scope of the present invention.

Referring again to FIG. 1, a vane body 38 is shown in relation to the stator housing 12 and rotor body 26. The vane body 38 is located in the vane slot 34 of the rotor body 26 and is free to move within the vane slot 34. The vane body 38 slides along the vane slot and as the piston 10 rotates, the vane moves within the rotor body 12. In effect, during rotation of the piston 10 the vane body 38 is floating in the vane slot 34.

FIG. 4 is a detailed cross section of the vane body 38 according to the present invention. The vane body 38 has a head portion 44 at each end. The head portion 44 has a face portion 42 and a back portion 40. The vane body 38 has a head portion 46 at the other end, also with a face portion 42 and a back portion 40. The vane body 38 has fluid channels 48 that communicate a working substance from the center of the vane body 38 to the face portion 42 of each head portion 44, 46.

The vane body 36 has a maximum length dimension 50 and the length dimension of the vane body 36 is slightly compressible. During rotation, pressure from the working substance equalizes the vane body 36 to the maximum length dimension 50 so that any forces exerted on the vane body 36 are equal and in opposite directions. This allows the vane body 36 to float in the vane slot 34.

Referring again to FIG. 1, the vane body 38 is slidable within the vane slot 34 of the rotor body 26 and will move slightly along the vane slot during the piston's revolution. In addition, the maximum length dimension 50 and head portions, 44 and 46, of the vane body 36 create a low-friction seal with the stator housing for each chamber 16. The low-friction seal is set by the maximum length dimension (not shown in FIG. 1) of the vane body 38 and the fixed internal dimension 14 of the stator housing. By design there may be slight clearance from the head portions of the vane body 38 to the inside of the stator housing 12 or there may be no clearance, or there may be slight pressure. The slight compressibility of the vane body 38 dampens vibrations during rotation. The head portions 44 and 46 of the vane body follow the internal dimension of the stator housing. At specific times during the piston's rotation, the head portions, 44 and 46, of the vane body 38 extend out of the vane slot 34 past the rotor body 26 or compress into the vane slot 34. Depending on the direction of rotation and the piston's application, as the vane body 38 crosses the seal boundary 22 the head portion 44 is completely recessed in the vane slot 34 as shown in FIG. 1 at a minimum chamber volume 52 (mcv), which is equivalent to a top-dead-center point of a conventional piston, for the chamber 16. At the opposite end of the vane body 38, the head portion 46 is at mid-stroke in its respective chamber 16 and is completely extended from the rotor body 26. One of the rotor arms 28 of the rotor body 26 creates a low-friction seal at the seal boundaries 22, 24 as well. In the embodiment shown in FIG. 1, a full chamber volume 54 (fcv), which is at a point equivalent to the bottom-dead-center point in a conventional piston, for a chamber, n, is the minimum chamber volume, or top-dead-center point, for a subsequent chamber, n+1.

As discussed above, the compressibility of the vane body 38 provides a smoother vane rotation for the rotary piston. For a given chamber the vane extends outward from the rotor body between the minimum chamber volume and a mid-stroke position. From the mid-stroke position to the maximum chamber volume, the vane is pushed back into the rotor body by the decreasing chamber. The transition of the vane body 38 between extending, stopping and then being pushed back in, requires damping to eliminate vibrations. The compressible, maximum-length vane body 38 of the present invention provides the necessary damping. A rigid, fixed-length vane operated at very low rpm's could provide a seal. However, the rigid, fixed-length vane operated at higher rpm's would generate vibrations and efficiency losses due to the dynamic forces.

The head portions 44 and 46 of the vane body 38 receive the force and perform the compression of a working substance within the chamber 16. The head portions 44 and 46 do work simultaneously by adding a force moment perpendicular to a torque arm created by the vane body 38 and the rotor body 26. The moment of force from each head is a sinusoidal function of rotation, as it is perpendicular to the face portion and proportional to the exposed face area. This moment of force function is exactly the same for each head portion 44 and 46 but is 180 degrees out of phase. The net force and torque applied to the rotor is the vector sum of these two force functions.

Sliding friction reduction is necessary on the back portion 40 of the head portion. Depending on the direction of rotation, the force applied to the face portion 42 of the head portion 44 pushes the back body portion 40 of the vane body 38 towards the rotor body vane slot 34. The vane body 38 floats inside the vane slot 34 and the fixed maximum length dimension establishes a good low-friction seal with the inside of the stator housing 12.

In a turbine application for the rotary piston 10 of the present invention, the working substance is delivered to the chamber 16 using a feed control system 56 shown in FIG. 5. The working substance can be either compressible or non-compressible. When the working substance is a compressible fluid, it is expanded from a high pressure and small volume to a low pressure and large volume within the chamber 16. Work done by the expanding substance within the chamber 16 is converted into rotational shaft work (not shown).

The feed control system 56 can be manual or automated. The feed control system 56 delivers a predetermined, or metered, amount of working substance to the chamber at some point between minimum chamber volume and full chamber volume for the chamber 16. It can be delivered all at once, or metered throughout the piston's revolution. Delivery can be delayed, or it can be commenced exactly at minimum chamber volume 52. The delivery method and amount of working substance depends on the particular design and application for the rotary piston 10. The delivery method and amount will determine a delivery profile and ultimately a working expansion profile of the working substance in the chamber.

Referring to FIG. 5, a feed, or delivery, controller 58 is shown for accomplishing these objectives. The controller 58 can be manually operated, or it can be automated to dynamically adjust according to predetermined parameters for the operation of the rotary piston. The feed controller 58 delivers the working substance through a delivery channel 60 to each chamber 16.

According to one embodiment of the present invention, the feed control system 56 delivers a high pressure compressible fluid into each chamber 16 beginning at the minimum chamber volume 52. Ideally and in a perfect design, at the minimum chamber volume, the chamber volume is zero, there is no flow and there is an absence of any pressure differential between the dispenser 60 and the pressure inside the chamber 16. As the pressure of the high-pressure fluid drives the chamber 16 from a small volume to a larger volume, expanding the chamber 16, the working substance is continually fed into the chamber 16. No expansion of the working substance takes place during this particular stage and the pressure inside the chamber 16 remains the same as the working substance source. The work product of this particular stage of the turbine is equal to the product of the pressure and the volume of the chamber.

When the feed is stopped, the pressurized working substance in the chamber continues to expand, producing additional work. Expansion of the working substance inside the expansion chamber continues until the full chamber volume 54 is reached. Rotation beyond full chamber volume 54 exhausts the working substance. The coefficient of expansion for the working substance is equal to the chamber volume divided by the predetermined volume of the working substance delivered by the feed control system.

It may be desirable to expand the working substance into a variety of situations. For example, depending on the application, the output desired, or other factors, the working substance may be completely expanded to ambient pressure, in which case the pressure at full chamber volume is equal to ambient pressure. It may be desirable to under-expand the working substance, in which case the chamber pressure at full chamber volume is greater than ambient. Further, it may be desirable to over-expand the working substance, in which case, the chamber pressure at cull chamber volume is less than ambient.

In any event, the feed control system 56 delivers a predetermined amount of high-pressure working substance to the chamber at any point between the minimum chamber volume and the full chamber volume to control the applied volume flow rate of the working substance and to manage the coefficient of expansion within the expansion chamber.

The present invention is advantageous in that it is completely scalable. The present invention, rather than being infinitely long, has working face that travels in a circle without reciprocation. There is no impact on the frequency of cycle because there is no reciprocation of mass. Therefore, the rotary piston of the present invention can be scaled to large dimensions without the drawback of traditional pistons. Further, the sealing edges scale proportionally to the scale of the working face, so scaling to very small sizes is also possible and practical with the present invention.

In a traditional turbine, low volume flow rate can only be accommodated by scaling the turbine to smaller dimensions, a micro-turbine. However, this is expensive and introduces parasitic inefficiencies that do not matter in large turbines, but become dominant factors in smaller turbines.

In a traditional turbine, maximum efficiency is accomplished by complete expansion of the working substance from a high pressure potential to a low pressure potential, which exists across the turbine itself. Complete expansion in a traditional turbine can only be accomplished by designing a physical turbine dimension and geometry to a steady state application of pressure and volume.

According to the present invention, the feed control system produces a dynamic pressure and flow situation. Feed control in the present invention manages the portion size of high-pressure working substance delivered to the chamber so that complete expansion is always possible, even for dynamic input conditions. Sensors 62 can be employed to sense changes in predetermined parameters, such as pressure inside the chamber, to allow the feed controller 58 to adjust flow rate and volume of the working substance into the chamber 16. This feature of the present invention provides a single design for a turbine that is capable of operating efficiently over a broad range of pressure and volume combinations and can be dynamically adjusted during its operation.

An example for the application of feed control of the present invention can be explained using the example of converting the potential work stored in a container of compressed gas, into shaft work in order to run a generator or drive gear. In this application, the incoming pressure decreases as the system is used. With feed control of the present invention, the pressure drop can be sensed and the portion size delivered to the chamber can be adjusted to provide steady state torque and rpm output, while maintaining maximum expansion efficiency. It is also possible to incorporate volume control to determine how much work out is provided at any given time. This output may be steady state, or a dynamic requirement that ranges from zero to a maximum output.

The present invention is efficient over a broad range of pressure differentials because it operates functionally like a piston that has a frictionless ring seal. Therefore, a very low pressure potential can be converted into work as efficiently as if it were a very high pressure potential. The work is equal to the force on the exposed face multiplied by the distance of motion. For a pressure source, which is only slightly higher than ambient, the force is small. However with a large working face, the actual work output can be large. For example, using wind at a speed of 25 mph, only a fraction of a psi is generated. Regardless of the low pressure, a large rotary turbine of the present invention could efficiently convert this force into usable work more efficiently than a conventional windmill. Because the rotary piston of the present invention can extract work form a dynamic source maintaining a fixed efficiency of conversion over a very broad range of pressure and flow volumes.

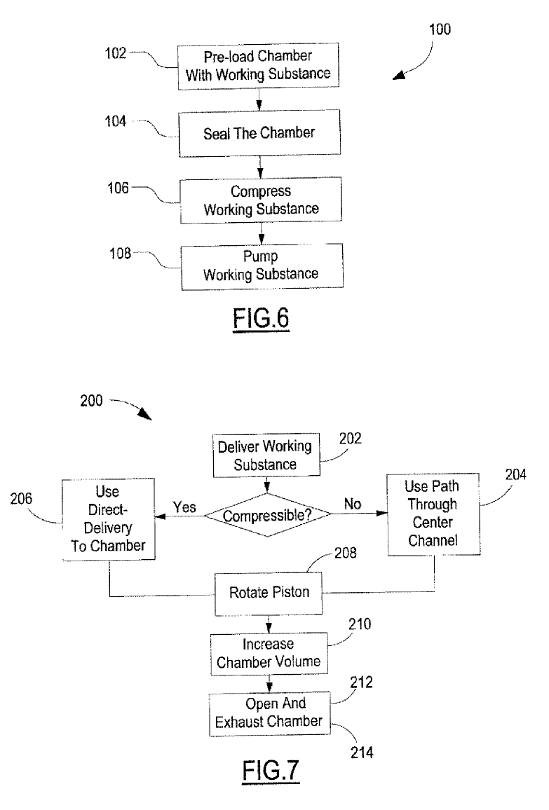

In one embodiment of the present invention, the rotary piston is operated as a pump to shift, transfer or compress a working substance from a large volume to a small volume. Operating as a pump, the rotary piston can compress a working substance to produce work that can be used to power another machine. Referring to FIG. 3, in pump/compressor mode 100 the rotary piston is operated such that the channels 36 are intake channels and the piston rotates in a direction such that the channels 36 lead and the vane slot 34 follows. FIG. 6 is a flow chart for the method 100 of operating the rotary piston of the present invention as a pump or compressor. The intake channels pre-load 102 each chamber with the working substance, typically a fluid or compressible gas, from an outside ambient source. As the piston rotates, the vane body and the internal dimension of the stator housing seals 104 the chamber. During rotation, the chamber, and therefore, the working substance is reduced in volume 106 as the vane body rotates through the chamber and produces a pumping, or compression, of the working substance trapped in the sealed chamber. As the rotor arm approaches the following seal boundary, the chamber volume is approaching zero, and the working substance is forced 108 through the fluid channels in the vane body producing the desired pumping/compressing action.

In another embodiment of the present invention, the rotary piston is operated as a turbine. Referring again to FIG. 3, for the turbine mode of operation, the piston rotates such that the vane slot 34 leads and the channels 36 trail. The channels 36 are for exhaust in the turbine mode.

FIG. 7 is a flow chart for the method 200 of operating the rotary piston as a turbine. The working substance is delivered 202 to the chamber. The turbine of the present invention can be operated using either a compressible or a non-compressible working substance. For a non-compressible working substance, delivery 202 is accomplished by allowing the working substance to flow 204 from a high pressure potential through the center channel and out the vane body fluid channels at any point on or after minimum chamber volume. For a compressible working substance, the working substance is delivered 206 from a high-pressure source to the chamber, following minimum chamber volume. In either case, a force is produced across the vane body face portion and this force rotates 208 the piston, in this example, the rotor body is rotating.

As the piston rotates 208, the chamber volume increases 210 until the full chamber volume is reached. At this point, there is no rotational force from the rotor body and the chamber is sealed at each end by the rotor arm to the stator housing. Further rotation of the rotor body will open 212 the chamber on the following seal boundary to the exhaust channel, which follows the rotor body, thereby exhausting 214 the working substance through the exhaust channel.

The method 200 of the present invention is capable of dynamic adjustment using the feed control system. The delivery of the working substance is controlled such that the rate of delivery, the volume delivered, and the coefficient of expansion of the working substance can all be controlled as desired to produce a desired output. As discussed earlier, the working substance delivery can be adjusted as desired. It can begin and end at any point between minimum chamber volume and full chamber volume. The rate and volume of the working substance delivery can be controlled as well.

There are several advantages associated with the present invention and applications are too numerous to mention herein. Some examples of advantages are the variety of applications that the rotary piston can be applied to. Further, the ability to scale the system's geometry presents opportunities that have not yet been available to the application of a rotary piston. For example, nano-scopic to giga-scopic turbines.

Several configurations of the rotary piston can be accomplished through varying the physical aspects of the piston. The rotor length, the rotor's internal and external dimensions and geometry, the pressure differential of the working substance, the number of stator nodes, the geometry of the stator nodes, the number and geometry of the rotor arms and channels, the geometry of the torque vane heads and body, number and geometry of the torque vane channels, as well as the rpm of the rotation of the piston.

Some general advantages not yet mentioned include a high conversion efficiency from fluid work into shaft work is accomplished for even low-pressure potentials and for varying input pressure and volume combinations. The rotary piston is capable of operating at low rpm's and provides a constant power stroke or compression stroke. It is relatively inexpensive to manufacture because there a few moving parts and they have specific, focused wear locations. Furthermore, this particular feature results in a rotary piston that is easily serviced. This also allows the material used to manufacture the piston to be either standard materials or exotic component materials. While exotic materials may not be suitable in a piston engine or conventional turbine applications, they may be used in other applications to attain a greater thermal or mechanical range of operation.

The working substance can be either a liquid or a gas because of the high seal capabilities. The operation is independent of temperature, and is limited only by the limitations associated with the materials used. As discussed above, the design can be either a fixed stator, rotating rotor or a fixed rotor, rotating stator design and there is no need for a flywheel or high ratio gearing. There are no vibrations resulting from reciprocating motion.

It can be seen that there has been presented a new and improved rotary piston.

What is claimed is:

1. A rotary piston comprising:
a stator housing having an internal dimension that remains fixed throughout a complete revolution of the rotary piston;
at least one chamber in the stator housing, the at least one chamber having a first end and a second end;
a rotor body inside the stator housing, the rotor body having a plurality of arms and a center channel therethrough defining a shaft axis as an axis of rotation for the rotary piston;
at least one vane slot in the rotor body that intersects the center channel;
a vane body freely movable and slidable within the at least one vane slot, the vane body being compressible for an adjustable length having a maximum length dimension, the vane body having a plurality of channels in communication with the center channel; a low-friction seal for the at least one chamber created between the stator housing and the vane body; a low friction seal for the at least one chamber created between the stator housing and at least one arm of the rotor body; and
a channel in communication with the at least one chamber for passing a working substance into and out of the at least one chamber.

2. The rotary piston as claimed in claim 1 further comprising:
a seal boundary at the first end of the at least one chamber;
a seal boundary at the second end of the at least one chamber;
the vane body follows the fixed internal dimension of the stator housing during rotation of the piston and a first head portion of the vane body extends beyond the rotor body during rotation of the piston while a second head portion is recessed in the rotor body; and the first head portion of the vane body compresses into the at least one vane slot at the seal boundaries while the second head portion extends beyond the rotor body.

3. The rotary piston as claimed in claim 2 wherein the first head portion of the vane body that extends beyond the vane slot in the rotor body receives a moment of force that is 180 degrees out of phase with a moment of force received by the second head portion of the vane body.

4. The rotary piston as claimed in claim 3 wherein the stator housing rotates and the rotor body remains fixed.

5. The rotary piston as claimed in claim 3 wherein the stator housing remains fixed and the rotor body rotates.

6. The rotary piston as claimed in claim 3 wherein the working substance further comprises a compressible fluid and the rotary piston further comprises a feed control system for introducing a predetermined amount of the working substance into the at least one chamber.

7. The rotary piston as claimed in claim 6 wherein the feed control system further comprises means for introducing the working substance under high pressure into a small chamber and expanding it to a low pressure in a large volume.

8. The rotary piston as claimed in claim 7 further comprising a dispenser of the feed control system and means for introducing the working substance any time between a minimum chamber volume and a full chamber volume, the minimum chamber volume being defined as a point in the at least one chamber where a volume of the at least one chamber is a minimum, there is an absence of flow of the working substance, there is an absence of a pressure differential between a pressure at the dispenser, the full chamber volume being defined as a point in the at least one chamber where the volume of the at least one chamber is a maximum, thereby initiating an expansion of the working substance in the at least one chamber as the volume of the chamber increases from a minimum to a maximum during rotation of the rotary piston.

9. The rotary piston as claimed in claim 8 further comprising means for introducing the working substance into the at least one chamber at exactly minimum chamber volume.

10. The rotary piston as claimed in claim 9 wherein the feed control system further comprises continually feeding the working substance into the at least one chamber as the rotary piston rotates from the minimum chamber volume to the full chamber volume.

11. The rotary piston as claimed in claim 8 wherein the feed control system further comprises means for introducing the working substance to completely expand the working substance to a point where the pressure inside the at least one chamber at full chamber volume is equal to ambient.

12. The rotary piston as claimed in claim 8 wherein the feed control system further comprises means for introducing the working substance to under-expand the working substance to a point where the pressure inside the at least one chamber at full chamber volume is greater than ambient.

13. The rotary piston as claimed in claim 8 wherein the feed control system further comprises means for introducing the working substance to over-expand the working substance to a point where the pressure inside the at least one chamber at full chamber volume is less than ambient.

14. The rotary piston as claimed in claim 6 further comprising means for controlling a steady-state volume flow rate of the working substance.

15. The rotary piston as claimed in claim 6 further comprising means for managing a coefficient of expansion within the at least one chamber.

16. The rotary piston as claimed in claim 15 wherein means for managing the coefficient of expansion further comprises means for sensing a change in pressure in the at least one chamber to dynamically adjust the predetermined amount of working substance introduced into the at least one chamber.

17. The rotary piston as claimed in claim 15 wherein means for managing the coefficient of expansion further comprises managing a steady state output of the rotary piston through delivery of the working substance into the at least one chamber.

18. The rotary piston as claimed in claim 15 wherein means for managing the coefficient of expansion further comprises managing a dynamic output of the rotary piston within a range of zero to a maximum output.

19. A turbine comprising:
a stator housing having an internal dimension that remains fixed throughout a complete revolution of the turbine;
at least one chamber in the stator housing, the at least one chamber having a first end and a second end;
a rotor body inside the stator housing, the rotor body having a plurality of arms and a center channel therethrough defining an axis of rotation;
at least one vane slot in the rotor body that intersects the center channel;
a vane body freely movable and slidable within the at least one vane slot, the vane body being compressible for an adjustable length dimension and having a fixed maximum length dimension the vane body having a plurality of channels in communication with the center channel;
a low-friction seal for the at least one chamber created between the stator housing and a head portion of the vane body;
a low-friction seal for the at least one chamber created between the stator housing and at least one arm of the rotor body;
a channel for the delivery of a predetermined, adjustable amount of working substance into the at least one chamber;
a channel for exhausting the working substance out of the at least one chamber; and
a feed control system for controlling the delivery of a predetermined, adjustable amount of the working substance into the at least one chamber any time between a minimum chamber volume and a full chamber volume, the minimum chamber volume being defined as a point in the at least one chamber where a volume of the at least one chamber is a minimum, there is an absence of flow of the working substance, there is an absence of a pressure differential between a pressure at the dispenser, the full chamber volume being defined as a point in the at least one chamber where the volume of the at least one chamber is a maximum, thereby initiating an expansion of the working substance in the at least one chamber as the volume of the chamber increases from a minimum to a maximum during rotation of the rotor body.

20. The turbine as claimed in claim 19 wherein the working substance further comprises a non-compressible working substance and the channel for delivery of the working substance into the at least one chamber further comprises a path through the center channel and the vane body channels.

21. The turbine as claimed in claim 19 wherein the working substance further comprises a compressible working substance and the channel for delivery of the working substance into the at least one chamber is directly into the chamber.

22. A method for operating a rotary piston having a stator housing having an internal dimension that remains fixed throughout a complete revolution of the rotary piston;
at least one chamber in said stator housing, the at least one chamber having a first end and a second end;
a rotor body inside the stator housing, the rotor body having a plurality of arms and a center channel therethrough defining a shaft axis as an axis of rotation for the rotary piston;
at least one vane slot in the rotor body that intersects the center channel;
a vane body freely movable and slidable within the at least one vane slot, the vane body being compressible for an adjustable length having a maximum length dimension and having a plurality of channels therethrough in communication with the center channel; and
a channel for passing a working substance into and out of the at least one chamber as a pump, the method comprising the steps of:
pre-loading the at least one chamber with a compressible working substance;
rotating the rotary piston in a direction such that the channel for delivery of the working substance leads and the vane body follows;
sealing the at least one chamber through the interface between the stator housing and a head portion of the vane body and through the interface between the stator housing and at least one arm of the rotor body;
rotating the rotary piston to reduce the volume of the chamber;
forcing the working substance through the channels in the vane body to create a pumping action of moving the compressed working substance through the rotary piston.

23. The method as claimed in claim 22 further comprising the step of operating the rotary piston as a compressor by converting the work product of the compressed working substance as a work source.

24. A method for operating a rotary piston having a stator housing having an internal dimension that remains fixed throughout a complete revolution of the rotary piston;
at least one chamber in said stator housing, the at least one chamber having a first end and a second end;
a rotor body inside the stator housing, the rotor body having a plurality of arms and a center channel therethrough defining an axis of rotation;
at least one vane slot in the rotor body that intersects the center channel;
a vane body freely movable and slidable within the at least one vane slot, the vane body being compressible for an adjustable length dimension and having a fixed maximum length dimension and a plurality of channels in communication with the center channel;
a low-friction seal for the at least one chamber created between the stator housing and the vane body;
a low-friction seal for the at least one chamber created between the stator housing and at least one arm of the rotor body;
a channel for the delivery of a predetermined, adjustable amount of working substance into the at least one chamber;
a channel for exhausting the working substance out of the at least one chamber; and
a feed control system for controlling the delivery of a predetermined, adjustable amount of the working substance into the at least one chamber any time between a minimum chamber volume and a full chamber volume, the minimum chamber volume being defined as a point in the at least one chamber where a volume of the at least one chamber is a minimum, there is an absence of flow of the working substance, there is an absence of a pressure differential between a pressure at the dispenser, the full chamber volume being defined as a point in the at least one chamber where the volume of the at least one chamber is a maximum, thereby initiating an expansion of the working substance in the at least one chamber as the volume of the chamber increases from a minimum to a maximum during rotation of the rotor body as a turbine, the method comprising the steps of:
delivering the working substance into the at least one chamber in a controlled, predetermined manner at some point after minimum chamber volume;
rotating the vane body through the at least one chamber; and
exhausting the working substance by rotating the vane body past full chamber volume.

25. The method as claimed in claim 24 wherein the step of delivering the working substance further comprises delivering a non-compressible working substance into the at least one chamber by a path through the center channel and the channels in the vane body.

26. The method as claimed in claim 24 wherein the step of delivering the working substance further comprises delivering a compressible working substance into the at least one chamber by a path directly into the at least one chamber.

27. The method as claimed in claim 24 further comprising the steps of: sensing a pressure in the at least one chamber; and adjusting a flow rate and volume of the working substance delivery into the at least one chamber.

28. The method as claimed in claim 24 wherein the step of delivering the working substance further comprises delivering the working substance continually between the minimum chamber volume and the full chamber volume.
